(19) United States
(12) Patent Application Publication
(10) Pub. No.: US 2024/0165733 A1
(43) Pub. Date: May 23, 2024

(54) RESISTANCE WELDING METHOD

(71) Applicant: KABUSHIKI KAISHA KOBE SEIKO SHO (KOBE STEEL, LTD.), Hyogo (JP)

(72) Inventors: Kyohei MAEDA, Kanagawa (JP); Reiichi SUZUKI, Kanagawa (JP)

(73) Assignee: KABUSHIKI KAISHA KOBE SEIKO SHO (KOBE STEEL, LTD.), Hyogo (JP)

(21) Appl. No.: 18/551,378

(22) PCT Filed: Feb. 8, 2022
(86) PCT No.: PCT/JP2022/004970

§ 371 Date: Sep. 19, 2023

(30) Foreign Application Priority Data
Mar. 22, 2021 (JP) 2021-047557

(51) Int. Cl. B23K 11/11

(52) U.S. Cl. CPC B23K 11/115

(57) ABSTRACT

A resistance welding method for joining together a first member and a second member with an element including a head portion and a shaft portion. The method includes: contacting the shaft portion with the first member to stack the element, the first member, and the second member in this order; sandwiching and pressurizing the element, the first member, and the second member with a pair of electrodes while pressurizing at least one of the element or the first member with an external pressurizing jig disposed around at least one electrode of the pair of electrodes that is closer to the element; and melting the first member by energization of the pair of electrodes while maintaining pressurization with the pair of electrodes and the external pressurizing jig so that the element penetrates the first member to weld the element and the second member together.

### TECHNICAL FIELD

The present invention relates to a resistance welding method, and more particularly to a resistance welding method for joining dissimilar metals such as a member made of a non-ferrous metal and a member made of a ferrous metal.

### BACKGROUND ART

Since it is difficult to directly join a non-ferrous metal such as aluminum or magnesium with a ferrous metal by spot welding used in the related art, a method of joining by mechanical joining with rivets such as self-piercing riveted (SPR) is generally used. In recent years, a method has been proposed in which a part of a non-ferrous metal is replaced with a ferrous metal using a flanged steel rivet (hereinafter referred to as an “element”), and the element and the ferrous metal are resistance-welded to each other, thereby indirectly joining dissimilar metals to each other. Particularly, from the viewpoint of productivity, attention is paid to a method of performing replacement with an element and joining with a ferrous metal in one step.

As the method of performing replacement with an element and joining with a ferrous metal in one step, for example, Patent Literature 1 discloses a method for manufacturing a dissimilar joint member in which a rivet (corresponding to the “element”) including a head portion, a shaft portion whose one end portion is coupled to the head portion, and a groove portion formed in a surface of the head portion on a shaft portion side is protruded from a first member while being pressurized and energized, and the shaft portion is inserted into the first member while causing the heat-softened or melted first member to flow into the groove portion, thereby joining the rivet and a second member. According to the manufacturing method, the melted first member is prevented from flowing out around the rivet, and generation of burrs can be prevented.

Patent Literature 2 discloses a dissimilar material joining method in which a first member is stacked on a second member, a rivet is installed on the first member, the rivet and the second member are pressurized and energized by an electrode tip, the rivet is penetrated into the first member by resistance heating in a first step, and a fusion zone is formed between the rivet and the second member in a second step. According to the joining method, the molten metal can be prevented from overflowing from the rivet by blowing air during joining.

Further, Patent Literature 3 discloses a joining method in which a button component (corresponding to the “element”) is pushed in, from a surface side, a second component made of a material different from a steel material with first pressure that is larger than second pressure during welding without heating, then the second pressure is applied, and a tip end portion of the penetrating button component and a first component made of a steel material are welded by resistance spot welding. According to the joining method, a structure made of a dissimilar metal material such as an aluminum material can be joined to a structure made of a steel material with higher strength without causing an increase in cost.

### CITATION LIST

### Patent Literature

Patent Literature 1: JP2018-43258A
Patent Literature 2: JP2020-69499A
Patent Literature 3: JP2018-61968A

### SUMMARY OF INVENTION

### Technical Problem

However, as a result of studies by the present inventors, it has been found that, in the related-art method as shown in the above Patent Literatures 1 to 3, a desired (that is, a high-strength) fusion zone is hardly formed between the element and the ferrous metal, and on the other hand, in order to form a desired fusion zone, energization with large heat input is required, and in this case, a welding defect frequently occurs.

Specifically, for example, in the dissimilar joining method disclosed in Patent Literatures 1 and 2, the rivet and the second member are spot-welded to each other by inserting the rivet including the groove portion into the heat-softened or melted first member and inserting the shaft portion into the first member while causing the heat-softened or melted first member to flow into the groove portion, and it has been found that the rivet is pushed upward by the heat-softened or melted first member flowing into the groove portion, which may hinder the formation of a desired fusion zone between the rivet and the second member.

In the joining method disclosed in Patent Literature 3, since the button component is forcibly pushed in, from the surface side, the second component made of a material different from a steel material in a non-heated state, the second component around the button component is warped upward, and thus the button component is easily pushed upward during welding, and formation of a desired fusion zone between the button component and the first component may be inhibited.

The present invention has been made in view of the above problems, and an object of the present invention is to provide a resistance welding method by which a desired fusion zone can be formed between an element made of a ferrous metal and a member made of a ferrous metal under energization conditions with a relatively low heat input, and a welding defect can be prevented.

### Solution to Problem

Therefore, the above object of the present invention is achieved by the following configuration [1] or [2] related to a resistance welding method.

[1] A resistance welding method for joining together a first member made of a non-ferrous metal and a second member made of a ferrous metal, with an element including a head portion and a shaft portion and made of a ferrous metal, the resistance welding method containing:
contacting the shaft portion with the first member to stack the element, the first member, and the second member in this order;
sandwiching and pressurizing the element, the first member, and the second member with a pair of electrodes while pressurizing at least one of the element or the first member with an external pressurizing jig disposed around at least one electrode of the pair of electrodes that is closer to the element; and
melting the first member by energization of the pair of electrodes while maintaining pressurization with the pair of electrodes and the external pressurizing jig so that the element penetrates the first member to weld the element and the second member together.

[2] A resistance welding method for joining together a first member made of a non-ferrous metal, a second member made of a ferrous metal, and a third member made of a ferrous metal, with an element including a head portion and a shaft portion, and the element being made of a ferrous metal, the resistance welding method containing:
contacting the shaft portion with the first member to stack the element, the first member, the second member, and the third member in this order;
sandwiching and pressurizing the element, the first member, the second member, and the third member with a pair of electrodes while pressurizing at least one of the element or the first member with an external pressurizing jig disposed around at least one electrode of the pair of electrodes that is closer to the element; and
melting the first member by energization of the pair of electrodes while maintaining pressurization with the pair of electrodes and the external pressurizing jig so that the element penetrates the first member to weld the element, the second member, and the third member together.

### Advantageous Effects of Invention

According to the resistance welding method of the present invention, at least one of the element or the member made of a non-ferrous metal is pressurized during welding with the external pressurizing jig disposed around the electrode, so that pushing up of the element with the member made of a non-ferrous metal and melted during welding is prevented. Therefore, a desired fusion zone can be formed between the element made of a ferrous metal and the member made of a ferrous metal under energization conditions with a relatively low heat input, and a welding defect can be prevented.

### BRIEF DESCRIPTION OF DRAWINGS

FIG. 1A and FIG. 1B are schematic cross-sectional views showing a step of forming a dissimilar material welded joint by a resistance welding method according to a first embodiment, in which FIG. 1A is a schematic cross-sectional view showing a state in which an element, a first member, and a second member are stacked in this order, the element, the first member, and the second member are sandwiched and pressurized with a pair of electrodes, and the element is pressurized with an external pressurizing jig disposed around each electrode of the pair of electrodes, and FIG. 1B is a schematic cross-sectional view showing a state in which the element and the second member are welded to each other by energization between the pair of electrodes.

FIG. 2 is a perspective view of the element as an example.

FIG. 3A is a perspective view showing a first example of a configuration related to the external pressurizing jig.

FIG. 3B is a perspective view showing a second example of the configuration related to the external pressurizing jig.

FIG. 4 is a graph showing an example of a relationship between welding pressure and a welding current with respect to an elapsed time during welding.

FIG. 5A and FIG. 5B are schematic cross-sectional views showing a step of forming a dissimilar material welded joint by a resistance welding method according to a second embodiment, in which FIG. 5A is a schematic cross-sectional view showing a state in which an element, the first member, and the second member are stacked in this order, the element, the first member, the second member are sandwiched and pressurized with a pair of electrodes, and the element is pressurized with an external pressurizing jig disposed only around one of the pair of electrodes that is closer to the element, and FIG. 5B is a schematic cross-sectional view showing a state in which the element and the second member are welded to each other by energization between the pair of electrodes.

FIG. 6A and FIG. 6B are schematic cross-sectional views showing a step of forming a dissimilar material welded joint by a resistance welding method according to a third embodiment, in which FIG. 6A is a schematic cross-sectional view showing a state in which an element, the first member, and the second member are stacked in this order, the element, the first member, and the second member are sandwiched and pressurized with a pair of electrodes, and the first member around a head portion of the element is pressurized with an external pressurizing jig disposed around each electrode of the pair of electrodes, and FIG. 6B is a schematic cross-sectional view showing a state in which the element and the second member are welded to each other by energization between the pair of electrodes.

FIG. 7A and FIG. 7B are schematic cross-sectional views showing a step of forming a dissimilar material welded joint by a resistance welding method according to a fourth embodiment, in which FIG. 7A is a schematic cross-sectional view showing a state in which an element, the first member, and the second member are stacked in this order, the element, the first member, the second member are sandwiched and pressurized with a pair of electrodes, and both the element and the first member around a head portion of the element are pressurized with an external pressurizing jig disposed around each electrode of the pair of electrodes, and FIG. 7B is a schematic cross-sectional view showing a state in which the element and the second member are welded to each other by energization between the pair of electrodes.

FIG. 8A and FIG. 8B are schematic cross-sectional views showing a step of forming a dissimilar material welded joint by a resistance welding method according to a fifth embodiment, in which FIG. 8A is a schematic cross-sectional view showing a state in which an element, the first member, the second member, and a third member are stacked in this order, the element, the first member, the second member, and the third member are sandwiched and pressurized with a pair of electrodes, and the element is pressurized with an external pressurizing jig disposed around each electrode of the pair of electrodes, and FIG. 8B is a schematic cross-sectional view showing a state in which the element, the second member, and the third member are welded to each other by energization between the pair of electrodes.

### DESCRIPTION OF EMBODIMENTS

Hereinafter, embodiments of a resistance welding method according to the present invention will be described in detail with reference to the drawings.

### First Embodiment

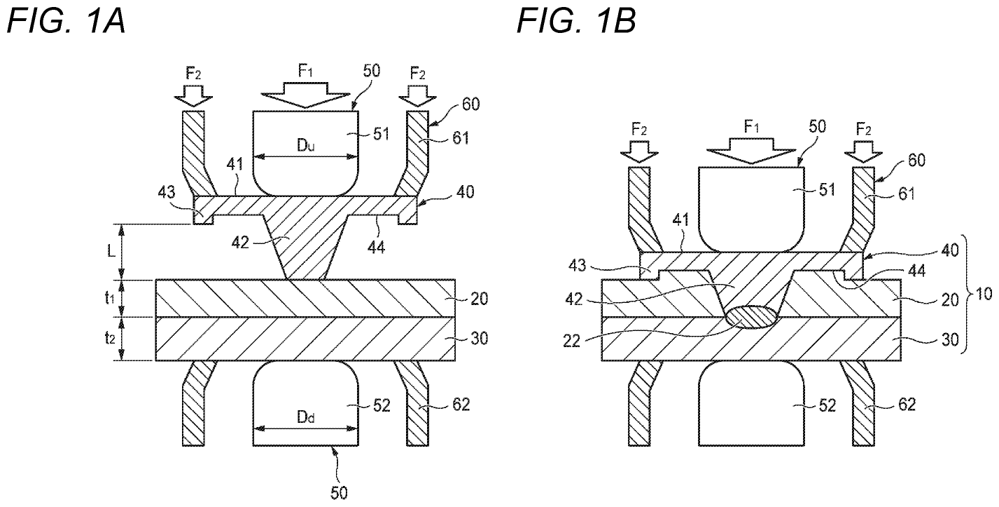

A resistance welding method according to a first embodiment of the present invention will be described with reference to FIGS. 1A to 4. FIG. 1A and FIG. 1B are schematic cross-sectional views showing a step of forming a dissimilar material welded joint by the resistance welding method according to the first embodiment.

As shown in FIG. 1A and FIG. 1B, the resistance welding method according to the present embodiment is a resistance welding method in which a first member 20 made of a non-ferrous metal such as aluminum or magnesium and a second member 30 made of a ferrous metal are stacked and joined using an element 40 made of a ferrous metal to form a dissimilar material welded joint 10. In the following description, in a stacked body obtained by stacking the element 40, the first member 20, and the second member 30 in this order, an element 40 side is referred to as an “upper side”, and a second member 30 side is referred to as a “lower side”.

The first member 20 and the second member 30 used in the present embodiment are plate-shaped members having plate thicknesses t₁ and t₂, respectively, and are not subjected to a pretreatment such as drilling and riveting.

A material of the first member 20 is not particularly limited as long as it is a ferrous material including pure iron or an iron alloy, and examples thereof include mild steel, carbon steel, and stainless steel. A material of the second member 30 is not particularly limited as long as it is a non-ferrous metal having a melting point lower than that of the ferrous metal, and examples thereof include pure aluminum, pure magnesium, an aluminum alloy, and a magnesium alloy.

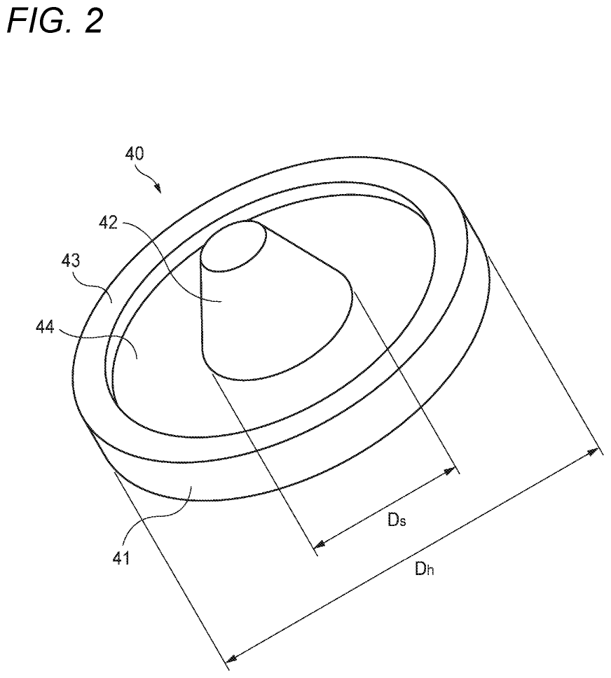

The element 40 is made of a ferrous metal, and as shown in FIG. 2 as an example, includes a substantially disk-shaped head portion 41, a substantially truncated cone-shaped shaft portion 42 formed to protrude from one surface of the head portion 41, an annular projecting portion 43 provided in the vicinity of an outer edge portion of the head portion 41 on the one surface, and an annular groove portion 44 formed between the shaft portion 42 and the annular projecting portion 43.

As shown in FIG. 2, a diameter Dₕ of the head portion 41 is larger than a diameter Ds of a root of the shaft portion 42. Thus, by forming the element 40 in a substantially T-shape in a cross-sectional view thereof (see the element 40 shown in FIG. 1A and FIG. 1B), restraining force to the first member 20 sandwiched between the second member 30 and the head portion 41 of the element 40 can be increased after completion of welding.

The shaft portion 42 has a substantially truncated cone shape tapered from the root toward a tip end portion, and accordingly, the element 40 can easily enter the first member 20 during resistance welding to be described later.

The groove portion 44 serves as a storage portion into which the melted first member 20 flows during resistance welding. As shown in FIG. 1A and FIG. 1B, a length L from a lower surface of the annular projecting portion 43 to a tip end of the shaft portion 42 is designed to be equal to or larger than the thickness t₁ of the first member 20. Accordingly, as will be described later, the shaft portion 42 of the element 40 and the second member 30 can be contacted with each other in a state where the first member 20 is sandwiched therebetween, and welding can be reliably performed between the members.

The shape of the head portion 41 is not particularly limited, and a round head, a flat head, a countersunk head, and further, a polygonal shape can be adopted as necessary. The shape of the shaft portion 42 is not limited to a truncated cone shape as shown in FIG. 2, and may be a cylindrical shape, a conical shape, or the like.

A material of the element 40 is not particularly limited as long as it is a ferrous material including pure iron or an iron alloy, and examples thereof include mild steel, carbon steel, and stainless steel.

A pair of electrodes 50 is a resistance spot welding electrode, and includes an upper electrode 51 and a lower electrode 52 that are disposed to face each other in a state where the element 40, the first member 20 and the second member 30 are interposed therebetween.

Further, a pair of external pressurizing jigs 60 is disposed vertically facing each other around the pair of electrodes 50 in a state where the element 40, the first member 20 and the second member 30 are interposed therebetween. The external pressurizing jig 60 includes a substantially circular ring-shaped upper external pressurizing jig 61 disposed around the upper electrode 51 and a substantially circular ring-shaped lower external pressurizing jig 62 disposed around the lower electrode 52.

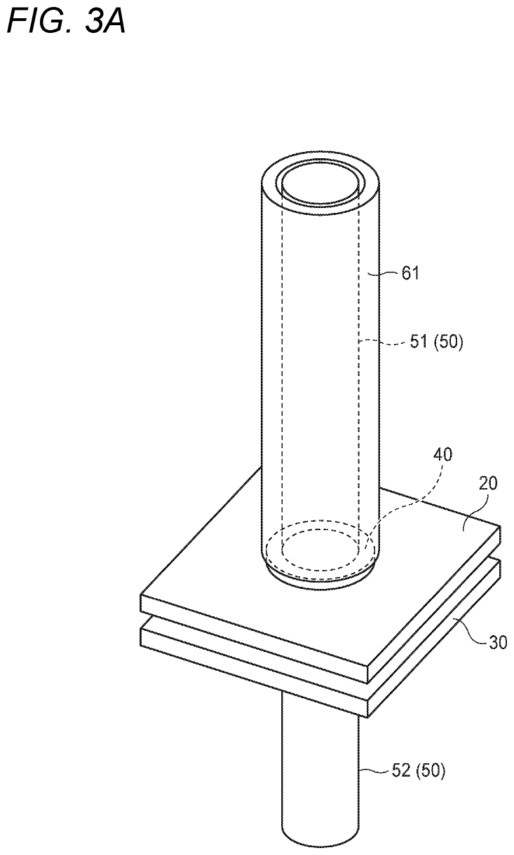

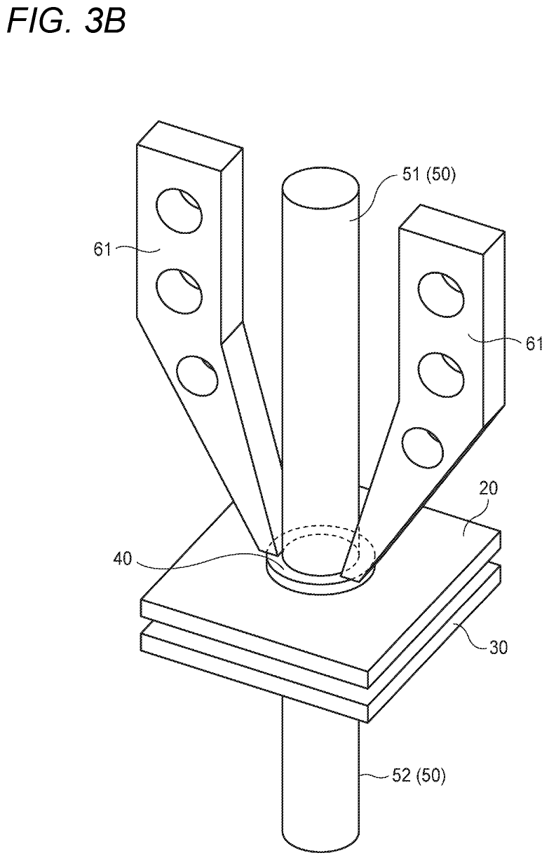

The upper external pressurizing jig 61 is not limited to a structure that pressurizes an entire circumference as a circular ring (for example, a concentric cross-section pipe) as shown in FIG. 3A, and for example, may be divided into a plurality of parts in a circumferential direction so as to pressurize at a plurality of points, or may have an arm-shaped structure as shown in FIG. 3B. The lower external pressurizing jig 62 is similar to the upper external pressurizing jig 61 described above.

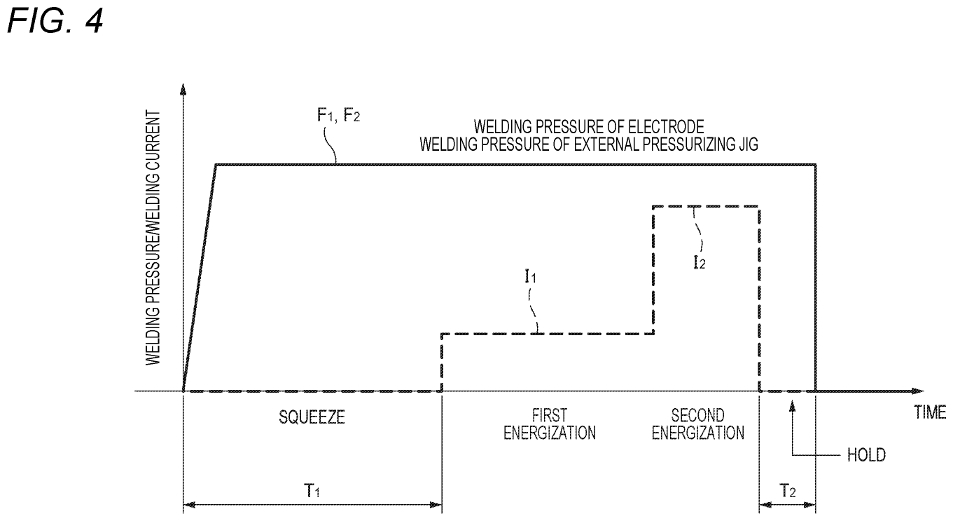

Next, a resistance welding method of the dissimilar material welded joint 10 will be described with reference to FIGS. 1 and 4.

In the resistance welding method according to the present embodiment, first, as shown in FIG. 1A, the first member 20 and the second member 30, which are constituent members of the dissimilar material welded joint 10, are stacked with each other, and further, the shaft portion 42 of the element 40 is contacted with the first member 20 to be in a pre-welding state.

Next, the upper electrode 51 and the upper external pressurizing jig 61 are contacted with an upper surface of the head portion 41 of the element 40, and the lower electrode 52 and the lower external pressurizing jig 62 are contacted with a lower surface of the second member 30, such that the element 40 and the second member 30 are sandwiched with the first member 20 interposed therebetween with the pair of electrodes 50 and the pair of external pressurizing jigs 60.

It is preferred that a portion of the upper external pressurizing jig 61 in contact with the element 40 is a portion of the element 40 radially outward of the shaft portion 42, in other words, a portion corresponding to the annular projecting portion 43 or the groove portion 44. Accordingly, the annular projecting portion 43 or the groove portion 44 of the element 40 can be pressed from the upper side, and as will be described later, when the element 40 enters the first member 20, pushing up of the element 40 due to an action of generating repulsive force accompanying deformation of the first member 20 and an action of liquid droplets, which are generated by melting of the first member 20, entering the groove portion 44 of the element 40 can be more effectively prevented.

Subsequently, the upper electrode 51 is pressurized with welding pressure F₁, and particularly in the present embodiment, the upper external pressurizing jig 61 is pressurized with welding pressure F₂ larger than the welding pressure F₁ to pressurize the element 40, the first member 20, and the second member 30.

In the present embodiment, the welding pressure F₂ of the upper external pressurizing jig 61 is described as being larger than the welding pressure F₁ of the upper electrode 51, but a magnitude of the welding pressure F₁ and the welding pressure F₂ can be changed according to welding conditions, and the welding pressure F₁ may be larger than or the same as the welding pressure F₂. FIG. 4 shows an example in which the welding pressure F₁ is equal to the welding pressure F₂.

As shown in FIG. 4, after holding for a predetermined squeeze time T₁, while maintaining pressurization with the pair of electrodes 50 (the upper electrode 51 and the lower electrode 52) and the pair of external pressurizing jigs 60 (the upper external pressurizing jig 61 and lower external pressurizing jig 62), a first current I₁, which is smaller than a second current I₂ during main welding, is caused to flow between the pair of electrodes 50 (first energization) to melt the first member 20, whose melting temperature is lower than that of the element 40 and the second member 30, to form a molten pool (not shown).

Accordingly, the element 40 that is pressurized with total pressure of the welding pressure F₁ and F₂ moves downward until the shaft portion 42 enters the molten pool of the first member 20 and penetrates the first member 20, and the tip end of the shaft portion 42 is contacted with the second member 30. As shown in FIG. 4, the reason why a small first current I₁ is initially used to energize is that, when a large current is used to energize from the beginning, the first member 20 may be melted at once and liquid droplets may scatter around. As the shaft portion 42 of the element 40 enters the molten pool of the first member 20, liquid droplets overflowing from the molten pool are accommodated in the annular groove portion 44 of the element 40, thereby preventing generation of burrs.

Here, when the element 40 enters the first member 20, force in a direction in which the tip end of the shaft portion 42 is separated from the second member 30 (that is, an upper direction in FIG. 1A and FIG. 1B) is applied due to the action of generating repulsive force accompanying deformation of the first member 20 and the action of liquid droplets, which are generated by melting of the first member 20, entering the groove portion 44 of the element 40. That is, the first member 20 melted during welding exerts force to push up the element. However, since the element 40 is not only sandwiched and pressurized with the upper electrode 51 and the lower electrode 52, but also sandwiched and pressurized with the upper external pressurizing jig 61 and the lower external pressurizing jig 62 disposed around the upper electrode 51 and the lower electrode 52, the element 40 can be prevented from being pushed up, and a contact state between the tip end of the shaft portion 42 and the second member 30 is favorably maintained during welding. Particularly, in the present embodiment, since the upper external pressurizing jig 61 pressurizes the portion of the element 40 radially outward of the shaft portion 42, movement of the element 40 in the upper direction can be more effectively prevented, and the contact state between the tip end of the shaft portion 42 and the second member 30 can be made more reliable.

As shown in FIG. 1B and FIG. 4, further, while maintaining pressurization with the pair of electrodes 50 and the pair of external pressurizing jigs 60, the second current I₂, which is a main welding current, is caused to flow between the upper electrode 51 and the lower electrode 52 (second energization) to form a fusion zone 22 between the tip end of the shaft portion 42 and the second member 30 by a normal spot welding method and weld the element 40 and the second member 30 together, thereby joining the ferrous metals to each other. Finally, the welding is completed by holding for a predetermined hold time T₂.

As described above, according to the resistance welding method of the first embodiment, the element 40 and the second member 30 are welded with the first member 20 interposed therebetween, with the welding pressure applied by the pair of electrodes 50 and the welding pressure applied by the pair of external pressurizing jigs 60 disposed around the pair of electrodes 50, and as compared with a related-art case where only the welding pressure applied by the pair of electrodes 50 is used, when the element 40 enters the first member 20, the pushing up of the element 40 due to the above-described action can be effectively prevented, so that a desired high-strength fusion zone can be formed without applying energization with large heat input. Accordingly, a desired fusion zone can be formed under energization conditions with a relatively low heat input, and therefore a welding defect can also be prevented.

It is particularly preferred that the welding pressure F₂ of the upper external pressurizing jig 61 is larger than the welding pressure F₁ of the upper electrode 51 as described in the present embodiment since the action of pushing up the element 40 can be more effectively prevented when the element 40 enters the first member 20.

Since the liquid droplets generated by the melting of the first member 20 enter the groove portion 44 of the element 40, the welding current may shunt to the liquid droplets in the groove portion 44 to make it difficult to form the fusion zone 22. Therefore, in order to prevent shunting of the welding current to the liquid droplets in the groove portion 44, a diameter Dᵤ of the upper electrode 51 is preferably substantially equal to the diameter Ds of the root of the shaft portion 42. The problem can also be solved by applying an adhesive or the like to a contact surface between the element 40 and the first member 20 to prevent the shunting. Further, a diameter D_{d} of the lower electrode 52 is not particularly limited, and is preferably substantially equal to the diameter Dᵤ of the upper electrode 51 in order to prevent interference with the lower external pressurizing jig 62.

Further, as described above, when the element 40 is pressurized with the external pressurizing jig 60, the external pressurizing jig 60 preferably pressurizes a portion of the head portion 41 of the element 40 radially outward of the shaft portion 42, and accordingly, the annular projecting portion 43 or the groove portion 44 of the element 40 can be pressed from the upper side, the first member 20 melted during welding flows into the groove portion 44, and thus the element 40 can be more effectively prevented from being pushed up.

### Second Embodiment

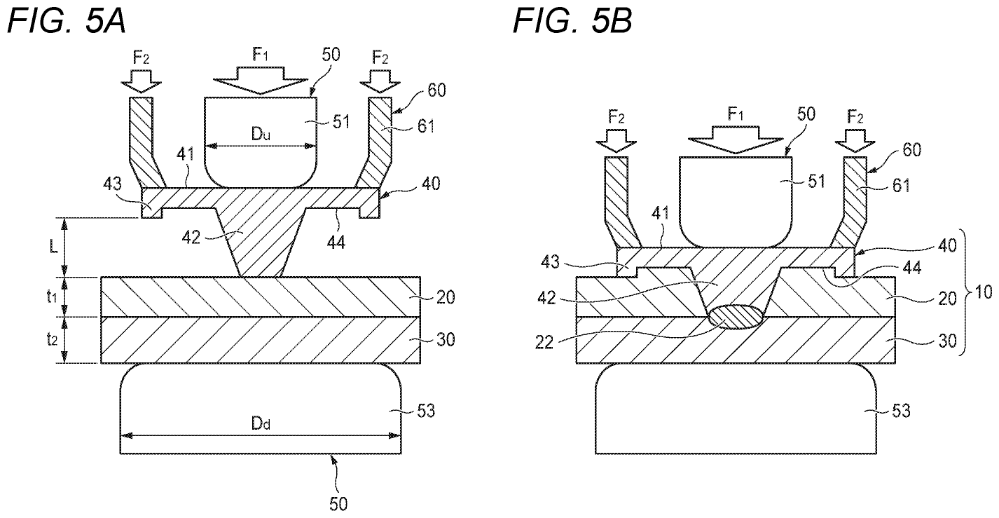

Next, a resistance welding method according to a second embodiment of the present invention will be described with reference to FIG. 5A and FIG. 5B. FIG. 5A and FIG. 5B are schematic cross-sectional views showing a step of forming a dissimilar material welded joint by the resistance welding method according to the second embodiment.

The resistance welding method according to the present embodiment differs from the resistance welding method according to the first embodiment in that the diameter D_{d} of the lower electrode 53 is substantially the same as the diameter Dₕ of the head portion 41 of the element 40, and the lower external pressurizing jig 62 is not provided. That is, a lower electrode 53 has both functions of the lower electrode 52 and the lower external pressurizing jig 62 in the first embodiment.

In the resistance welding method according to the present embodiment, first, as shown in FIG. 5A, the first member 20 and the second member 30, which are constituent members of the dissimilar material welded joint 10, are stacked with each other, and further, the shaft portion 42 of the element 40 is contacted with the first member 20 to be in a pre-welding state.

Next, the upper electrode 51 and the upper external pressurizing jig 61 are contacted with an upper surface of the head portion 41 of the element 40, the lower electrode 53 is contacted with a lower surface of the second member 30, such that the element 40 and the second member 30 are sandwiched with the first member 20 interposed therebetween with the pair of electrodes 50 (the upper electrode 51 and the lower electrode 53) and the external pressurizing jig 60 (the upper external pressurizing jig 61).

In the present embodiment, as in the first embodiment, a portion of the upper external pressurizing jig 61 in contact with the element 40 is a portion of the element 40 radially outward of the shaft portion 42, in other words, a portion corresponding to the annular projecting portion 43 or the groove portion 44.

Then, the upper electrode 51 and the upper external pressurizing jig 61 are pressurized with the welding pressure F₁ and F₂, respectively.

Next, while maintaining pressurization with the pair of electrodes 50 and the external pressurizing jig 60, the first current I₁ and the second current I₂ are caused to flow in this order between the pair of electrodes 50, as in the first embodiment, to finally form the fusion zone 22 between the tip end of the shaft portion 42 and the second member 30 and weld the element 40 and second member 30 together, thereby joining the ferrous metals to each other.

Since the other parts are the same as those of the resistance welding method of the first embodiment, the same parts are denoted by the same reference numerals or corresponding reference numerals, and the description thereof will be simplified or omitted.

As described above, according to the resistance welding method of the second embodiment, as in the first embodiment, the element 40 and the second member 30 are welded with the first member 20 interposed therebetween, with the welding pressure applied by the pair of electrodes 50 and the welding pressure applied by the pair of external pressurizing jigs 60 disposed around the pair of electrodes 50, and as compared with a related-art case where only the welding pressure applied by the pair of electrodes 50 is used, when the element 40 enters the first member 20, the pushing up of the element 40 due to the above-described action, specifically, an action of generating repulsive force accompanying deformation of the first member 20 during entry of the element 40 and an action of liquid droplets, which are generated by melting of the first member 20, entering the groove portion 44 of the element 40 can be effectively prevented, so that a desired high-strength fusion zone can be formed without applying energization with large heat input. Accordingly, a desired fusion zone can be formed under energization conditions with a relatively low heat input, and therefore a welding defect can also be prevented.

The lower electrode 53 receives both the welding pressure F₁ applied by the upper electrode 51 and the welding pressure F₂ applied by the upper external pressurizing jig 61, and serves as both the lower electrode 52 and the lower external pressurizing jig 62 in the first embodiment. Since the resistance welding method according to the present embodiment does not include the lower external pressurizing jig 62, a resistance welding mechanism can be simplified and a cost can be reduced.

On the other hand, in the resistance welding method according to the first embodiment described above, the external pressurizing jig 60 is disposed not only around the electrode (that is, the upper electrode 51) of the pair of electrodes 50 that is closer to the element 40 but also around the electrode (that is, the lower electrode 52) of the pair of electrodes 50 that is farther from the element 40. According to such a configuration, the welding pressure F₁ applied by the upper electrode 51 and the welding pressure F₂ applied by the upper external pressurizing jig 61 can be received, and a tip end diameter of the lower electrode 52 can be made substantially equal to a tip end diameter of the upper electrode 51, so that an increase in energization area during resistance welding due to a difference in electrode size between the upper and lower electrodes in the pair of electrodes 50 can be minimized, and a current value required to secure a nugget diameter can be reduced.

### Third Embodiment

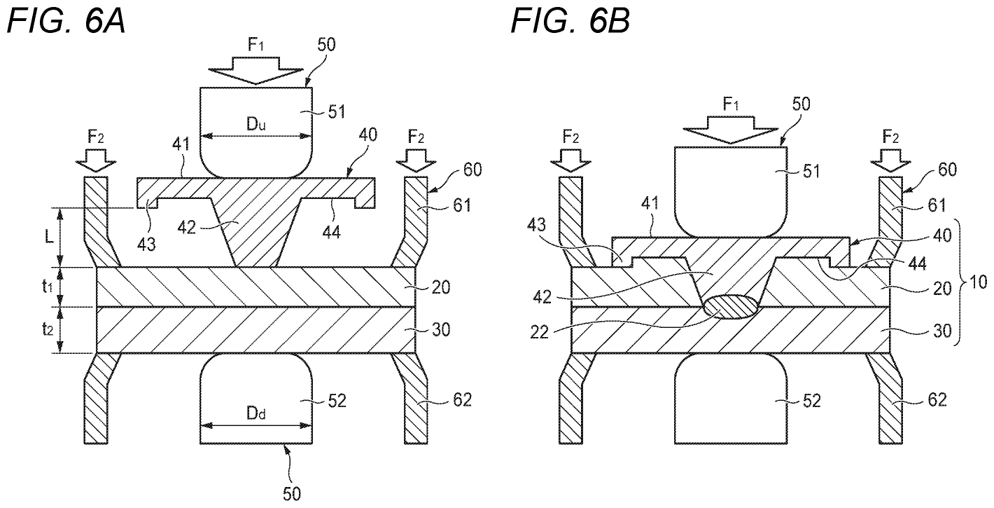

Next, a resistance welding method according to a third embodiment of the present invention will be described with reference to FIG. 6A and FIG. 6B. FIG. 6A and FIG. 6B are schematic cross-sectional views showing a step of forming a dissimilar material welded joint by the resistance welding method according to the third embodiment.

The resistance welding method according to the present embodiment differs from the resistance welding method according to the first embodiment in that the external pressurizing jig 60 pressurizes the first member 20 instead of the element 40.

In the resistance welding method according to the present embodiment, first, as shown in FIG. 6A, the first member 20 and the second member 30, which are constituent members of the dissimilar material welded joint 10, are stacked with each other, and further, the shaft portion 42 of the element 40 is contacted with the first member 20 to be in a pre-welding state.

Next, the upper electrode 51 is contacted with an upper surface of the head portion 41 of the element 40, the upper external pressurizing jig 61 is contacted with an upper surface of the first member 20, and the lower electrode 52 and the lower external pressurizing jig 62 are contacted with a lower surface of the second member 30, such that the element 40 and the second member 30 are sandwiched with the first member 20 interposed therebetween by the pair of electrodes 50 (the upper electrode 51 and the lower electrode 52) and the pair of external pressurizing jigs 60 (the upper external pressurizing jig 61 and the lower external pressurizing jig 62).

Since the upper external pressurizing jig 61 pressurizes the first member 20 instead of the element 40, an inner diameter of the circular ring-shaped upper external pressurizing jig 61 is formed to be larger than the diameter Dₕ of the head portion 41. An inner diameter of the lower external pressurizing jig 62 disposed to face the upper external pressurizing jig 61 is also substantially the same as the inner diameter of the upper external pressurizing jig 61.

Then, the upper electrode 51 and the upper external pressurizing jig 61 are pressurized with the welding pressure F₁ and F₂, respectively.

Next, while maintaining pressurization with the pair of electrodes 50 and the pair of external pressurizing jigs 60, the first current I₁ and the second current I₂ are caused to flow in this order between the pair of electrodes 50, as in the first embodiment, to finally form the fusion zone 22 between the tip end of the shaft portion 42 and the second member 30 and weld the element 40 and the second member 30 together, thereby joining the ferrous metals to each other.

Since the other parts are the same as those of the resistance welding method of the first embodiment, the same parts are denoted by the same reference numerals or corresponding reference numerals, and the description thereof will be simplified or omitted.

As described above, according to the resistance welding method of the third embodiment, as in the first embodiment, the element 40 and the second member 30 are welded with the first member 20 interposed therebetween, with the welding pressure applied by the pair of electrodes 50 and the welding pressure applied by the pair of external pressurizing jigs 60 disposed around the pair of electrodes 50, and as compared with a related-art case where only the welding pressure applied by the pair of electrodes 50 is used, when the element 40 enters the first member 20, the pushing up of the element 40 due to the above-described action, specifically, an action of generating repulsive force accompanying deformation of the first member 20 during entry of the element 40 and an action of liquid droplets, which are generated by melting of the first member 20, entering the groove portion 44 of the element 40 can be effectively prevented, so that a desired high-strength fusion zone can be formed without applying energization with large heat input. Accordingly, a desired fusion zone can be formed under energization conditions with a relatively low heat input, and therefore a welding defect can also be prevented.

### Fourth Embodiment

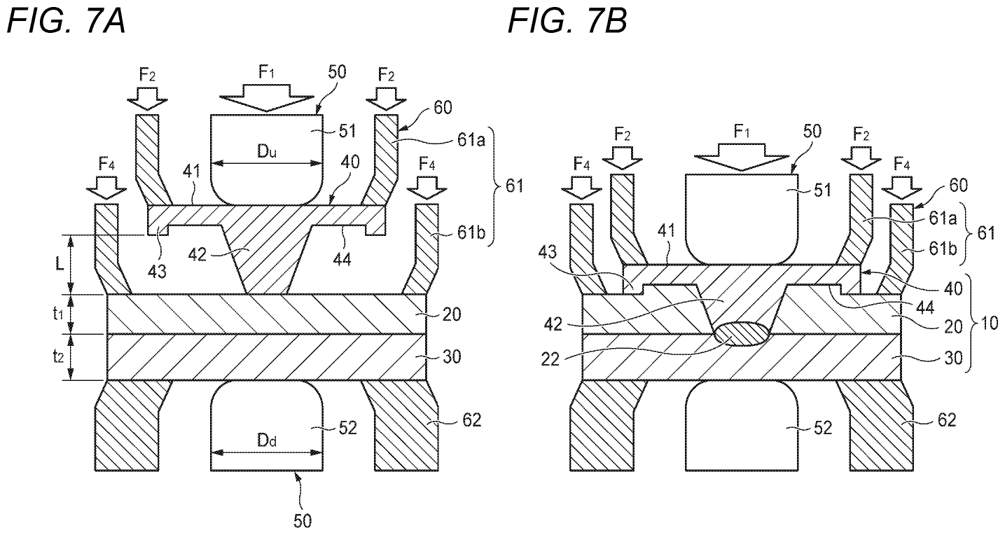

Next, a resistance welding method according to a fourth embodiment of the present invention will be described with reference to FIG. 7A and FIG. 7B. FIG. 7A and FIG. 7B are schematic cross-sectional views showing a step of forming a dissimilar material welded joint by the resistance welding method according to the fourth embodiment.

The resistance welding method according to the present embodiment is a welding method combining the resistance welding method according to the first embodiment and the resistance welding method according to the third embodiment. As in the first embodiment and the third embodiment, the upper electrode 51 and the lower electrode 52 are provided that sandwich and pressurize the element 40, the first member 20, and the second member 30 to perform welding. Shapes and actions of the upper electrode 51 and the lower electrode 52 are the same as those in the resistance welding method of the first embodiment.

The external pressurizing jig 60 formed in a substantially circular ring shape is provided radially outward of each of the upper electrode 51 and the lower electrode 52. The external pressurizing jig 60 includes the upper external pressurizing jig 61 and the lower external pressurizing jig 62.

Further, the upper external pressurizing jig 61 includes a first upper external pressurizing jig 61a that is contacted with a portion of the element 40 radially outward of the shaft portion 42 to pressurize the element 40, and a second upper external pressurizing jig 61b that pressurizes the first member 20 around the head portion 41 of the element 40. That is, the upper external pressurizing jig 61 includes the first upper external pressurizing jig 61a and the second upper external pressurizing jig 61b that are arranged on two circumferences substantially concentrically.

The lower external pressurizing jig 62 is formed in a substantially circular ring shape radially outward around the lower electrode 52, and is formed to have a large contact area with the second member 30 so as to face the first upper external pressurizing jig 61a and the second upper external pressurizing jig 61b.

In the resistance welding method according to the present embodiment, the element 40, the first member 20, and the second member 30 are sandwiched with the upper electrode 51, the first upper external pressurizing jig 61a, the second upper external pressurizing jig 61b, the lower electrode 52, and the lower external pressurizing jig 62. The upper electrode 51 is pressurized with the welding pressure F₁, the first upper external pressurizing jig 61a is pressurized with the welding pressure F₂, the second upper external pressurizing jig 61b is pressurized with welding pressure F₄, and while maintaining pressurization with the pair of electrodes 50 and the pair of external pressurizing jigs 60, the first current I₁ and then the second current I₂ are applied in this order for energizing between the upper electrode 51 and the lower electrode 52, to melt the first member 20 and form the fusion zone 22 between the shaft portion 42 of the element 40 and the second member 30, thereby welding the element 40 and the second member 30.

Since the other parts are the same as those of the resistance welding method of the first embodiment, the same parts are denoted by the same reference numerals or corresponding reference numerals, and the description thereof will be simplified or omitted.

As described above, according to the resistance welding method of the fourth embodiment, as in the first embodiment and the third embodiment, the element 40 and the second member 30 are welded with the first member 20 interposed therebetween, with the welding pressure applied by the pair of electrodes 50 and the welding pressure applied by the pair of external pressurizing jigs 60 disposed around the pair of electrodes 50, and as compared with a related-art case where only the welding pressure applied by the pair of electrodes 50 is used, when the element 40 enters the first member 20, the pushing up of the element 40 due to the above-described action, specifically, an action of generating repulsive force accompanying deformation of the first member 20 during entry of the element 40 and an action of liquid droplets, which are generated by melting of the first member 20, entering the groove portion 44 of the element 40 can be effectively prevented, so that a desired high-strength fusion zone can be formed without applying energization with large heat input. Accordingly, a desired fusion zone can be formed under energization conditions with a relatively low heat input, and therefore a welding defect can also be prevented.

Particularly, in the third embodiment, since both the element 40 and the first member 20 are pressurized with the external pressurizing jig 60, the action of pushing up the element 40 can be particularly effectively prevented when the element 40 enters the first member 20.

### Fifth Embodiment

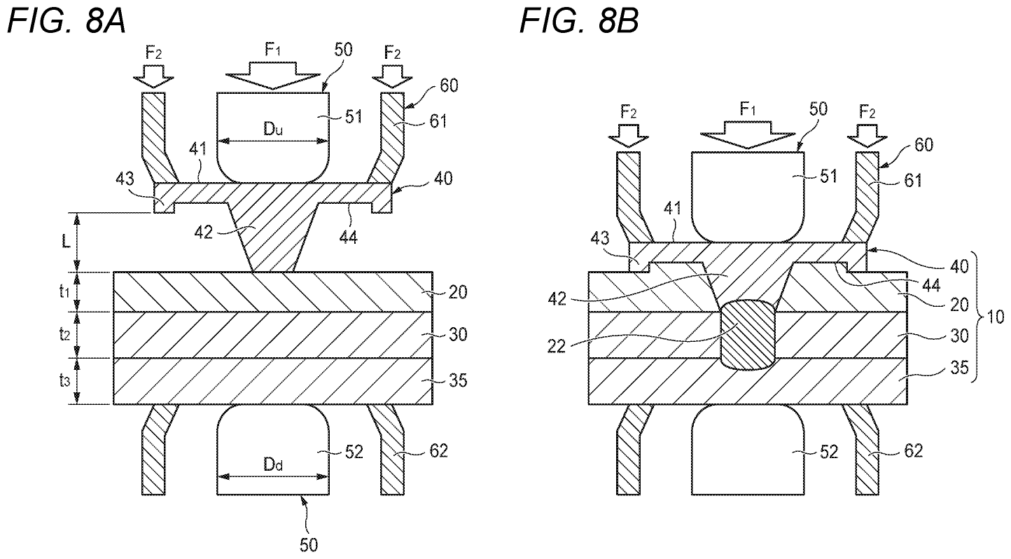

Next, a resistance welding method according to a fifth embodiment of the present invention will be described with reference to FIG. 8A and FIG. 8B. FIG. 8A and FIG. 8B are schematic cross-sectional views showing a step of forming a dissimilar material welded joint by the resistance welding method according to the fifth embodiment.

The resistance welding method according to the present embodiment is the same as the resistance welding method of the first embodiment, and is a resistance welding method in which the first member 20 made of a non-ferrous metal such as an aluminum alloy or a magnesium alloy, the second member 30 made of a ferrous metal, and a third member 35 made of a ferrous metal are stacked and joined using the element 40 made of a ferrous metal to form the dissimilar material welded joint 10. The present embodiment is different from the first embodiment in that the dissimilar material welded joint 10 of the first embodiment is two sheet-stacked, whereas the dissimilar material welded joint 10 of the present embodiment is three sheet-stacked.

In the resistance welding method according to the present embodiment, the element 40, the first member 20, the second member 30, and the third member 35 are sandwiched with the upper electrode 51 and the upper external pressurizing jig 61, and the lower electrode 52 and the lower external pressurizing jig 62. The upper electrode 51 is pressurized with the welding pressure F₁, the first upper external pressurizing jig 61a is pressurized with the welding pressure F₂, and while maintaining pressurization with the pair of electrodes 50 and the pair of external pressurizing jigs 60, the first current I₁ and then the second current I₂ are applied in this order for energizing between the upper electrode 51 and lower electrode 52, to melt the first member 20 and form the fusion zone 22 among the shaft portion 42 of the element 40, the second member 30, and the third member 35, thereby welding the element 40, the second member 30, and the third member 35.

Since the other parts are the same as those of the resistance welding method of the first embodiment, the same parts are denoted by the same reference numerals or corresponding reference numerals, and the description thereof will be simplified or omitted.

As described above, according to the resistance welding method of the fifth embodiment, as in the first embodiment, the element 40, the second member 30, and the third member 35 are welded with the first member 20 interposed therebetween, with the welding pressure applied by the pair of electrodes 50 and the welding pressure applied by the pair of external pressurizing jigs 60 disposed around the pair of electrodes 50, and as compared with a related-art case where only the welding pressure applied by the pair of electrodes 50 is used, when the element 40 enters the first member 20, the pushing up of the element 40 due to the above-described action, specifically, an action of generating repulsive force accompanying deformation of the first member 20 during entry of the element 40 and an action of liquid droplets, which are generated by melting of the first member 20, entering the groove portion 44 of the element 40 can be effectively prevented, so that a desired high-strength fusion zone can be formed without applying energization with large heat input. Accordingly, a desired fusion zone can be formed under energization conditions with a relatively low heat input, and therefore a welding defect can also be prevented.

In the above description, the second member 30 is described as being made of a ferrous metal, but may also be made of a non-ferrous metal. That is, both the first member 20 and the second member 30 are made of a non-ferrous metal. In this case, the length L from the lower surface of the annular projecting portion 43 to the tip end of the shaft portion 42 in the element 40 is designed to be a total thickness of the thickness t₁ of the first member 20 and the thickness t₂ of the second member 30. Accordingly, the shaft portion 42 of the element 40 and the third member 35 can be contacted with each other with the first member 20 and the second member 30 sandwiched therebetween, and welding can be reliably performed between the members.

In the present embodiment, the dissimilar material welded joint 10 may be three-layered, or may be more than three-layered, that is, four or more-layered. In the case of the four-layered dissimilar material welded joint 10, a non-ferrous metal, a ferrous metal, a ferrous metal, and a ferrous metal are stacked in this order from an upper side, or a non-ferrous metal, a non-ferrous metal, a non-ferrous metal, and a ferrous metal are stacked in this order from an upper side.

Although the first to fifth embodiments have been described in detail, the present invention is not limited to the above-described embodiments, and modifications, improvements, and the like can be appropriately made.

As described above, the present description discloses the following matters.

(1) A resistance welding method for joining together a first member made of a non-ferrous metal and a second member made of a ferrous metal, with an element including a head portion and a shaft portion and made of a ferrous metal, the resistance welding method containing:
contacting the shaft portion with the first member to stack the element, the first member, and the second member in this order;
sandwiching and pressurizing the element, the first member, and the second member with a pair of electrodes while pressurizing at least one of the element or the first member with an external pressurizing jig disposed around at least one electrode the pair of electrodes that is closer to the element; and
melting the first member by energization of the pair of electrodes while maintaining pressurization with the pair of electrodes and the external pressurizing jig so that the element penetrates the first member to weld the element and the second member together.

According to this configuration, at least one of the element 40 or the first member 20 made of a non-ferrous metal is pressurized during welding with the external pressurizing jig 60 disposed around the electrode 50, so that pushing up of the element 40 due to the first member 20 melted during welding is prevented. Therefore, a desired fusion zone can be formed between the element 40 made of a ferrous metal and the second member 30 made of a ferrous metal under energization conditions with a relatively low heat input, and a welding defect can be prevented.

(2) The resistance welding method according to the above (1), wherein welding pressure applied by the external pressurizing jig to pressurize the element or the first member is larger than welding pressure applied by the pair of electrodes to sandwich and pressurize the element, the first member, and the second member.

According to this configuration, the action of pushing up the element 40 can be more effectively prevented when the element 40 enters the first member 20.

(3) A resistance welding method for joining together a first member made of a non-ferrous metal, a second member made of a ferrous metal, and a third member made of a ferrous metal, with an element including a head portion and a shaft portion, and the element being made of a ferrous metal, the resistance welding method containing:
contacting the shaft portion with the first member to stack the element, the first member, the second member, and the third member in this order;
sandwiching and pressurizing the element, the first member, the second member, and the third member with a pair of electrodes while pressurizing at least one of the element or the first member with an external pressurizing jig disposed around at least one electrode of the pair of electrodes that is closer to the element; and
melting the first member by energization of the pair of electrodes while maintaining pressurization with the pair of electrodes and the external pressurizing jig so that the element penetrates the first member to weld the element, the second member, and the third member together.

According to this configuration, at least one of the element 40 or the first member 20 made of a non-ferrous metal is pressurized during welding with the external pressurizing jig 60 disposed around the electrode 50, so that pushing up of the element 40 due to the first member 20 melted during welding is prevented. Therefore, a desired fusion zone can be formed between the element 40 made of a ferrous metal and the second member 30 made of a ferrous metal and the third member 35 under energization conditions with a relatively low heat input, and a welding defect can be prevented.

(4) The resistance welding method according to the above (3), wherein a welding pressure applied by the external pressurizing jig to pressurize the element or the first member is larger than a welding pressure applied by the pair of electrodes to sandwich and pressurize the element, the first member, the second member, and the third member.

According to this configuration, the action of pushing up the element 40 can be more effectively prevented when the element 40 enters the first member 20.

(5) The resistance welding method according to any one of the above (1) to (4), wherein the external pressurizing jig is disposed around each electrode of the pair of electrodes.

According to this configuration, the welding pressure F₁ applied by the upper electrode 51 and the welding pressure F₂ applied by the upper external pressurizing jig 61 can be received, and a tip end diameter of the lower electrode 52 can be made substantially equal to a tip end diameter of the upper electrode 51, so that an increase in energization area during resistance welding due to a difference in electrode size between the upper and lower electrodes in the pair of electrodes 50 can be minimized, and a current value required to secure a nugget diameter can be reduced.

(6) The resistance welding method according to any one of the above (1) to (5), wherein both the element and the first member are pressurized with the external pressurizing jig

According to this configuration, the action of pushing up the element 40 can be particularly effectively prevented when the element 40 enters the first member 20.

(7) The resistance welding method according to any one of the above (1) to (6), wherein
when the element is pressurized with the external pressurizing jig,
the external pressurizing jig pressurizes a portion of the head portion of the element, the portion being radially outward of the shaft portion.

According to this configuration, the annular projecting portion 43 or the groove portion 44 of the element 40 can be pressed from the upper side, and when the element 40 enters the first member 20, pushing up of the element 40 due to an action of generating repulsive force accompanying deformation of the first member 20 and an action of liquid droplets, which are generated by melting of the first member 20, entering the groove portion 44 of the element 40 can be more effectively prevented.

Although various embodiments have been described above with reference to the drawings, it is needless to say that the present invention is not limited to such examples. It is apparent that those skilled in the art can conceive of various modifications and alterations within the scope described in the claims, and it is understood that such modifications and alterations naturally fall within the technical scope of the present invention. In addition, the respective constituent elements in the above-described embodiments may be freely combined without departing from the gist of the invention.

The present application is based on Japanese Patent Application No. 2021-047557 filed on Mar. 22, 2021, contents of which are incorporated herein by reference.

### REFERENCE SIGNS LIST

10 Dissimilar material welded joint
20 First member
30 Second member
35 Third member
40 Element
41 Head portion
42 Shaft portion
50 Pair of electrodes
51 Upper electrode (electrode closer to element)
60 Pair of external pressurizing jigs
F₁ Welding pressure of electrode
F₂, F₄ Welding pressure of external pressurizing jig

1. A resistance welding method for joining together a first member made of a non-ferrous metal and a second member made of a ferrous metal with an element including a head portion and a shaft portion, the element being made of a ferrous metal, the resistance welding method comprising:
contacting the shaft portion with the first member to stack the element, the first member, and the second member in this order;
sandwiching and pressurizing the element, the first member, and the second member with a pair of electrodes while pressurizing at least one of the element or the first member with an external pressurizing jig disposed around at least one electrode of the pair of electrodes that is closer to the element; and
melting the first member by energization of the pair of electrodes while maintaining pressurization with the pair of electrodes and the external pressurizing jig so that the element penetrates the first member to weld the element and the second member together.

2. The resistance welding method according to claim 1, wherein a welding pressure applied by the external pressurizing jig to pressurize the element or the first member is larger than a welding pressure applied by the pair of electrodes to sandwich and pressurize the element, the first member, and the second member.

3. The resistance welding method according to claim 1, wherein the external pressurizing jig is disposed around both electrodes.

4. The resistance welding method according to claim 1, wherein both the element and the first member are pressurized with the external pressurizing jig.

5. The resistance welding method according to claim 3, wherein both the element and the first member are pressurized with the external pressurizing jig.

6. The resistance welding method according to claim 1, wherein
when the element is pressurized with the external pressurizing jig,
the external pressurizing jig pressurizes a portion of the head portion of the element, the portion being radially outward of the shaft portion.

7. The resistance welding method according to claim 3, wherein
when the element is pressurized with the external pressurizing jig,
the external pressurizing jig pressurizes a portion of the head portion of the element, the portion being radially outward of the shaft portion.

8. The resistance welding method according to claim 4, wherein
when the element is pressurized with the external pressurizing jig,
the external pressurizing jig pressurizes a portion of the head portion of the element, the portion being radially outward of the shaft portion.

9. The resistance welding method according to claim 5, wherein
when the element is pressurized with the external pressurizing jig,
the external pressurizing jig pressurizes a portion of the head portion of the element, the portion being radially outward of the shaft portion.

10. A resistance welding method for joining together a first member made of a non-ferrous metal, a second member made of a ferrous metal, and a third member made of a ferrous metal with an element including a head portion and a shaft portion and, the element being made of a ferrous metal, the resistance welding method comprising:
contacting the shaft portion with the first member to stack the element, the first member, the second member, and the third member in this order;
sandwiching and pressurizing the element, the first member, the second member, and the third member with a pair of electrodes while pressurizing at least one of the element or the first member with an external pressurizing jig disposed around at least one electrode of the pair of electrodes that is closer to the element; and
melting the first member by energization of the pair of electrodes while maintaining pressurization with the pair of electrodes and the external pressurizing jig so that the element penetrates the first member to weld the element, the second member, and the third member together.

11. The resistance welding method according to claim 10, wherein a welding pressure applied by the external pressurizing jig to pressurize the element or the first member is larger than a welding pressure applied by the pair of electrodes to sandwich and pressurize the element, the first member, the second member, and the third member.

12. The resistance welding method according to claim 10, wherein the external pressurizing jig is disposed around both electrodes.

13. The resistance welding method according to claim 10, wherein both the element and the first member are pressurized with the external pressurizing jig.

14. The resistance welding method according to claim 12, wherein both the element and the first member are pressurized with the external pressurizing jig.

15. The resistance welding method according to claim 10, wherein
when the element is pressurized with the external pressurizing jig,
the external pressurizing jig pressurizes a portion of the head portion of the element, the portion being radially outward of the shaft portion.

16. The resistance welding method according to claim 12, wherein
when the element is pressurized with the external pressurizing jig,
the external pressurizing jig pressurizes a portion of the head portion of the element, the portion being radially outward of the shaft portion.

17. The resistance welding method according to claim 13, wherein
when the element is pressurized with the external pressurizing jig,
the external pressurizing jig pressurizes a portion of the head portion of the element, the portion being radially outward of the shaft portion.

18. The resistance welding method according to claim 14, wherein
when the element is pressurized with the external pressurizing jig,
the external pressurizing jig pressurizes a portion of the head portion of the element, the portion being radially outward of the shaft portion.
